(19) United States
(12) Patent Application Publication
(10) Pub. No.: US 2024/0320374 A1
(43) Pub. Date: Sep. 26, 2024

(54) MULTI-PERSON ACCESS CONTROL

(71) Applicant: Alarm.com Incorporated, Tysons, VA (US)

(72) Inventors: Wen-Ting Zhu, Fairfax, VA (US); Donald Gerard Madden, Columbia, MD (US); Krishna Chaitanya Tummalapalli, Falls Church, VA (US)

(21) Appl. No.: 18/610,908

(22) Filed: Mar. 20, 2024

Related U.S. Application Data
(60) Provisional application No. 63/453,321, filed on Mar. 20, 2023.

(51) Int. Cl. G06F 21/62; G06F 21/32; G06V 40/16

(52) U.S. Cl. CPC G06F 21/629; G06F 21/32; G06V 40/172; G06F 2221/2141

(57) ABSTRACT

Methods, systems, and apparatus, including computer programs encoded on computer storage media, for multi-person authentication and access control. One of the methods includes determining, by a system and using sensor data i) captured by one or more sensors and ii) that is different data than input data captured by one or more input devices, whether a number of people, who performed corresponding input actions, satisfies an access criteria a) for accessing a critical function and b) that requires two or more predetermined input actions; and performing, by the system, an action for the critical function in response to determining whether the number of people, who performed corresponding input actions, satisfies the access criteria a) for accessing the critical function and b) that requires the two or more predetermined input actions.

### CROSS-REFERENCE TO RELATED APPLICATION

This application claims the benefit of U.S. Provisional Application No. 63/453,321, filed Mar. 20, 2023, the contents of which are incorporated by reference herein.

### BACKGROUND

Security systems can provide protection for various properties, whether homes or residences. Security systems can control sensitive or critical operations. Sometimes, security systems can provide features other than security features, such as home automation features.

### SUMMARY

Some security systems require input from multiple people before allowing access to critical functions, such as restricted resources. Some examples of critical functions can include execution of a process or restricted resources such as a door, e.g., to a vault or a building, or secure computer resources, e.g., confidential data. To operate most accurately, such security systems should verify that both the correct people and the correct codes are entered in order to validate access to the critical functions. This can include the system verifying that the persons who were assigned particular access codes actually entered those access codes, or used corresponding keys, rather than someone else.

A security system can use one or more cameras of a critical function location to ensure that the correct people are given access to a critical function. For instance, as multiple people use corresponding access codes or other types of input, e.g., keys, the security system can receive images of the critical function location. The security system can verify that the people are the people to whom the access codes were given, are living, e.g., rather than an image of the person, or both. When the security system verifies that the correct people entered the access codes, and the correct access codes were entered, the security system can allow access to the critical function. For instance, the security system can open the door, provide access to the secure computer resources, or both.

In general, one innovative aspect of the subject matter described in this specification can be embodied in methods that include the actions of determining, by a system and using sensor data i) captured by one or more sensors and ii) that is different data than input data captured by one or more input devices, whether a number of people, who performed corresponding input actions, satisfies an access criteria a) for accessing a critical function and b) that requires two or more predetermined input actions; and performing, by the system, an action for the critical function in response to determining whether the number of people, who performed corresponding input actions, satisfies the access criteria a) for accessing the critical function and b) that requires the two or more predetermined input actions.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, performing the action can include providing access to the critical function in response to determining that the number of people, who performed corresponding input actions, satisfies the access criteria a) for accessing the critical function and b) that requires the two or more predetermined input actions. The method can include determining that each of the two or more predetermined input actions was performed by a different person from the people who performed corresponding input actions. Performing the action can be responsive to determining that each of the two or more predetermined input actions was performed by a different person from the people who performed corresponding input actions.

In some implementations, performing the action can include sending an alert about access to the critical function. Sending the alert about the access to the critical function can be responsive to determining that the number of people, who performed corresponding input actions, does not satisfy the access criteria a) for accessing the critical function and b) that requires the two or more predetermined input actions.

In some implementations, the method can include accessing the input data that indicates input entered into the one or more input devices by a corresponding person. Determining whether the number of people, who performed the corresponding input actions, satisfies the access criteria a) for accessing the critical function and b) that requires the two or more predetermined input actions can include comparing first image data depicting a first person who performed a first input action with second image data depicting a second person who performed a second input action. Comparing the first image data depicting the first person who performed the first input action with the second image data depicting the second person who performed the second input action can include at least one of: analyzing, using a facial recognition process, at least one of the first image data or the second image data; or analyzing, using gait analysis, at least a portion of data from at least one of the first image data and the second image data.

In some implementations, determining whether the number of people, who performed the corresponding input actions, satisfies the access criteria a) for accessing the critical function and b) that requires the two or more predetermined input actions can include determining a likelihood that the sensor data indicates that the people can be likely living humans. Determining a likelihood that the sensor data indicates that the people can be likely living humans can use an amount of movement of a corresponding object detected in the sensor data.

In some implementations, determining whether the number of people, who performed the corresponding input actions, satisfies the access criteria a) for accessing the critical function and b) that requires the two or more predetermined input actions can include determining whether a number of input actions matches the number of people depicted in image data captured at one or more locations where the input actions were performed.

In some implementations, determining whether the number of people, who performed the corresponding input actions, satisfies the access criteria a) for accessing the critical function and b) that requires the two or more predetermined input actions can include determining whether each of the two or more predetermined input actions was likely performed voluntarily. Determining whether each of the two or more input actions was likely performed voluntarily can use at least one of image data or audio data.

The subject matter described in this specification can be implemented in various embodiments and may result in one or more of the following advantages. In some implementations, the systems and methods described in this specification can increase security, e.g., by only performing an action for a critical function upon verifying that a number of people who performed corresponding actions satisfies an access criteria. In some implementations, the systems and methods described in this specification can increase a likelihood that the protections already in place to protect a critical action are maintained in place. In some implementations, the systems and methods improves efficiency of determining whether a number of people satisfy an access criteria by analyzing sensor data, minimizing the inputs from a user, e.g., of passwords or biometrics, or both. In some implementations, the system and methods described in this document can provide early notification to the people who are determined to no be present.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment with a multi-person access control system.

FIG. 2 is a flow diagram of a process for the multi-person access control system.

FIG. 3 is a diagram illustrating an example of a property monitoring system.

Like reference numbers and designations in the various drawings indicate like elements.

### DETAILED DESCRIPTION

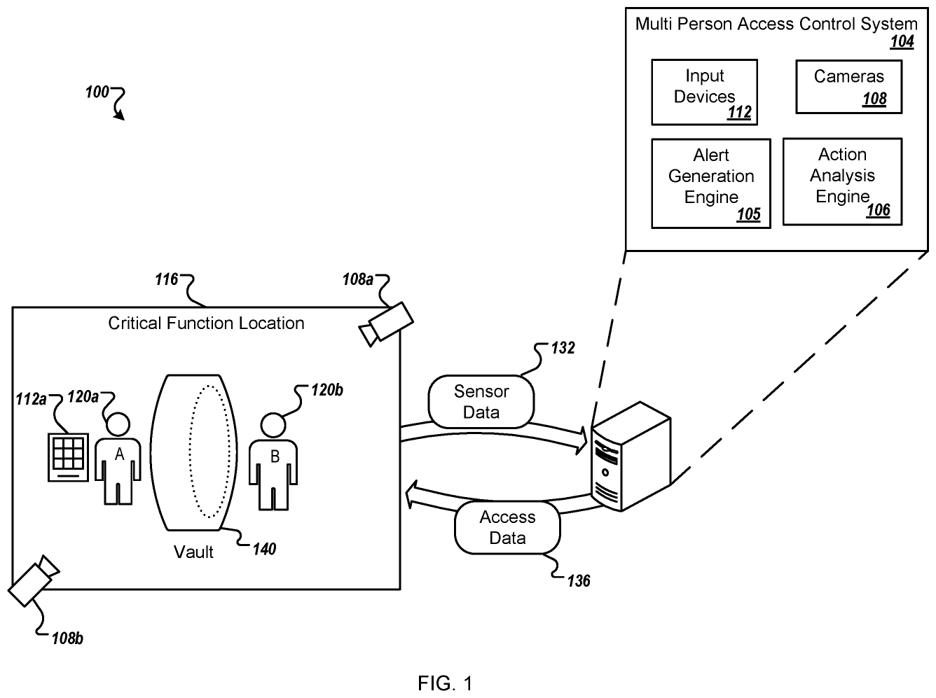

FIG. 1 depicts an example environment 100 with a multi-person access control system 104. The multi-person access control system 104 can verify whether particular required people are present prior to an event. The multi-person access control system 104 can include, but is not limited to sensors, input devices 112, speakers, displays, an alert generation engine 105, an action analysis engine 106, other devices, or a combination of these. The system can use cameras 108a and 108b to monitor the critical function location 116 and can ensure that the appropriate required people 120a-b are present for the event. This can prevent a single person from performing the event, and accessing the critical function, when multiple people are required for access to the critical function. The system can verify input provided by one or more input devices 112a in addition to verifying that the appropriate required people 120a-b are present. The multi-person access control system 104 can use sensor data 132 to verify groups of people for an event and send access data 136 to an access controlling device, e.g., a door, to grant access to a critical function, such as a vault 140.

The critical function location 116 can be any appropriate type of location for a critical function. For instance, the critical function location 116 can include a door, a room, an entryway, or any other appropriate location. The critical function location can be defined as an area that tools must remain in. The critical function location 116 can be a location that persons must remain outside of, in, or a combination of both. For example, the critical function location 116 can be an area that is dangerous and an operation should not continue with persons within those spaces.

The critical function can be any appropriate function. The vault 140 is an example of a critical function. Other examples of critical functions can include a computer, a server, a safe, an electric panel, an engine, a database, a material, an object, an equipment, and more.

The multi-person access control system 104 can require two or more people 120a-b to be present for the operation of the critical function. For instance, the critical function requires two or more people for the multi-person access control system 104 to provide access to the critical function. When the critical function is the vault 140, the two or more people can include a manager and a security personnel, e.g., at a bank.

To provide access to the critical function, the multi-person access control system 104 requires multiple forms of verification. For instance, the multi-person access control system 104 can require verification of input into one or more input devices 112 and verification from and the authentication of the required persons 120a-b or any other appropriate persons present in the area.

The input device 112 can be of various types including but not limited to a keypad, key, an RFID badge reader, a biometrics scanner, a mobile device input device, a visual input device, or a combination of these. The input device 112 can be located remote to the critical function location. The input device 122 can be accessed remotely by the people present, for instance with a cellular device through the internet. The input device 122 can be accessed by a third person (not shown), for example, a remote person can press a button to unlock vault 140 from a physically remote location. Input to the input device 112 can be schedule or time related. For example, input device 112a is a keypad located within critical function location 116, e.g., and the keypad only accepts inputs during working hours. The input device 112 or 112a can be located within the critical function location 116, in another area, or both.

The input device 112a can receive input from one or both of the required people 120a-b. For instance, the multi-person access control system 104 might prevent access to the vault 140 until the input device 112a, or multiple input devices 112, receive input from the required people 120a-b. In some examples, a corresponding one of the input devices 112 can receive input from a corresponding one of the required people 120a-b, e.g., a first input device 112a can receive input from the first person 120a while a second input device (not shown) receives input from the second person 120b. In some implementations other people 120a-b provide input to separate input devices 112 at nearly the same time, in a sequence, or a combination of both. In some implementations, the input devices 112 are keypads, keyboards, buttons, key or electronic key ports, biometric scanners, e.g., a retina scanner or a fingerprint scanner, or any appropriate input device.

The multi-person access control system 104 can receive data from the input devices 112 that represents the corresponding input. The multi-person access control system 104 can verify that the data is correct. For example, when the input includes a user name and password, or a particular input for a corresponding one of the input devices 112, the multi-person access control system 104 can verify that a password is correct for a corresponding user name, that the particular input is correct for the corresponding one of the input devices 112, or a combination of both. When a manager and a security personnel are requesting access to the vault 140, the data from the input devices 112 can include a first password input by the manager and a second password input by the security personnel. In some examples, input can include a spoken password, a PIN, a password or any other input provided through an input device. When inputs are provided and the multi-person access control system 104 can determine whether the input data satisfies a threshold for authentication, access, preconditions for access, or any combination thereof.

The multi-person access control system 104 can use sensors or other devices or methods to verify that the required people are in place for access to the critical function. For example, person A 120a is only allowed access to the vault 140 if accompanied by person B 120b and the proper PIN is entered into the input device 112a. If only person A were present or a combination of people A and B with any other person were present, the multi-person access control system 104 can deny access even if the correct PIN were entered into input device 112a. However, since person A might gain access to the person B′s PIN, verification using the input alone might not necessarily be sufficient to determine that all of the required people A and B are at the critical function location 116 for access to the critical function. In some examples, the multi-person access control system can use the inputs to determine whether the inputs satisfy the input threshold for access. Some examples of the inputs can include a PIN input, a second person standing within the critical function area, and a third supervisor watching the second person. In some implementations, the multi-person access control system can verify that people are present and require no other input. In these implementations, the system can utilize verification of the presence of one or more predetermined people alone as a condition used to grant access to the critical function.

The cameras 108 can monitor the area for people, for objects, conditions, or a combination thereof. The multi-person access control system 104 can use data from the cameras 108 to verify that all of the required people 120a-b are at the critical function location 116 before providing access to the critical function, e.g., the vault 140. For instance, the cameras 108 can capture one or more images that depict, as the person A 120a, a manager and, as the person B 120b, a security personnel. One image can depict both required people 120a-b. In some examples, a first image depicts one of the required people, e.g., the person A 120a, and a second image depicts the other of the required people, e.g., the person B 120b.

One of the cameras 108, or another component in the multi-person access control system 104, can analyze the one or more images to detect the people 120a-b, and any other people at the critical function location 116. For instance, the multi-person access control system 104 can use any appropriate object recognition process to detect people depicted in images captured by the cameras 108. The multi-person access control system 104 can determine which people are depicted in the images, which objects are depicted in the images, or both. The multi-person access control system can use the sensor data captured by the cameras or the analyzed data in determining whether conditions are satisfied for access.

In examples in which the input received by the input devices 112 must be entered by a particular person, the multi-person access control system 104 can determine, through sensor data such as camera sensor data, whether the images depict the correct person entering the correct password. For instance, the multi-person access control system 104 can determine whether the images depict the manager entering the first password and the security personnel entering the second password.

The multi-person access control system 104 can include one or more sensors. The sensors can monitor the critical function location 116. For instance, the sensors can capture sensor data of the critical function location 116. The multi-person access control system 104 can receive the sensor data 132 from the one or more sensors. For example, the sensors can include the cameras 108a-b that capture images of the critical function location 116, motion sensors at the critical function location 116, metal detectors, pressure sensors, thermal sensors, ultrasonic sensors, or any other appropriate type of sensor. In some examples the sensor data can represent visual input such as actions taken within the monitored critical function location 116 or surrounding area. The sensor data from the cameras can represent input actions such as waving, standing in a certain position, standing in a certain area, e.g., at a biometric scanner, entering a password into an input device such as a keyboard or keypad, any other appropriate action captured by the sensors, or a combination of two or more of these.

Continuing the above example, the multi-person access control system 104 can determine whether sensor data for each of the persons 120a-b satisfies criteria for the corresponding person for example, whether a person is likely a living person. For instance, the multi-person access control system 104 can determine whether first sensor data indicates that the manager is alive, e.g., and not a cardboard cutout. The first sensor data can be thermal sensor data, or other appropriate data such as movement data, data indicating multiple viewing angles of one or more people, or data transmitted from devices on or being worn by the persons. The multi-person access control system 104 can determine whether second sensor data indicates that the security personnel is alive, does not have any prohibited items, e.g., with metal detector data, or satisfies other appropriate criteria.

The action analysis engine 106 can receive the sensor data 132 and can determine whether conditions are satisfied to allow access to vault 140. The sensors data 132 can indicate whether persons 120a-b are present in the critical function location 116, input is received from input device 112a, or both. Multiple factors and controls can provide input to the action analysis engine 106 including a manual override, remote control, or other methods of altering the conditions of access.

The action analysis engine 106 can add, remove, or alter conditions under which access is granted through determination based on programing, user input, or both. For example, the action analysis engine 106 can affect the time during which access is permitted, or what materials (e.g., tools) are permitted in the work area, or the minimum number of people required to be present to supervise an operation. Inputs to the analysis engine 106 can include the time, persons, sensor data, e.g., the input to the input devices 112, other conditions, or a combination of these, under which access to the critical function is granted. The reasons for these requirements can include, but are not limited to, safety, security, auditability, fraud detection, performance monitoring, compliance with regulations, and legal obligations. In some examples, by adding, removing, or altering conditions under which access is granted, the action analysis engine 106 can make the multi-person access control system 104 more accurate, less likely to provide access when access should not be provided, or both.

For example, the action analysis engine 106 can receive the input data from the input devices 112, and sensor data from the sensors. The action analysis engine 106 can determine one or more access criteria, e.g., rules or thresholds, that define conditions under which to grant access to the critical function. When the action analysis engine 106 determines that its inputs satisfy at least one of the one or more rules, the action analysis engine 106 can generate access data 136 that indicates that access to the critical function is granted. When the inputs do not satisfy any of the one or more rules, the action analysis engine 106 can generate access data 136 that indicates that access to the critical function is not granted.

The conditions under which access to the critical function can be provided can include a combination of input data from input devices and sensor data from sensors, e.g., in and around the critical function area. For instance, the multi-person access control system, using the action analysis engine, can determine using sensor data that the appropriate people are present and can determine the appropriate input data is entered. Determining, using sensor data, whether the appropriate people are present can include performing, using sensor data, visual identification of persons with cameras, the placement of persons within the area, or a combination of both. The action analysis engine can use sensor data to determine whether the appropriate equipment is present in the appropriate locations, for example, using LIDAR, ultrasonic sensors, radio frequency tags, or any other appropriate means to determine the presence and appropriate location of individuals or items to satisfy the conditions under which access is granted. The action analysis engine can use input data to determine whether the correct persons or equipment are present to satisfy the conditions under which access is granted. For instance, the action analysis engine can use input data such as passwords, PINs, biometric scans, or any other appropriate means to determine whether the conditions in and around the critical function area satisfy the conditions under which access is granted.

Various components in the environment 100 can use the access data 136 to control elements within the critical function location 116 in response to multi-person access control system determinations. In some examples, the system can provide the access data 136 in response to the conditions in the area satisfying one or more thresholds or other criteria, manual override, or a combination of both. For instance, if the proper conditions are established in critical function location 116, the access data 136 sent can indicate that access should be allowed. If the conditions in the critical function location 116 are not met for access, the access data 136 can still be sent by means of manual override. If the conditions in the critical function location 116 are not met for access, the access data 136 can be sent that denies access.

Various components in the environment 100 can receive the access data 136 and can perform one or more actions using the access data 136. For instance, the locks associated with the vault 140 can receive access data 136 indicating that access is granted and unlock the vault 140 door. Some components can receive the access data 136 and perform actions that indicate access is either granted or denied. For example, a display can illuminate a green light to indicate access is granted or a red-light indicating access is denied, in response to receiving access data 136.

The alert generation engine 105 can alert people to authorized access, attempted access, time limits, or any combination thereof. For instance, the alert generation engine 105 can provide a notification to persons 120a-b of the time remaining to complete a task before access is restricted. The alert generation engine 105 can provide an alert to persons 120a-b that conditions for access are no longer met. For example, if person 120a-bhave access to the vault 140, but a third person (not show) approaches, the alert generation engine 105 can provide an alert to the authorized persons 120a-b that access will soon be removed due to unauthorized persons being present.

In some implementations, the conditions are not satisfied for access. For instance, if two of the conditions are satisfied (e.g., two persons are in the correct location), but a third is not (e.g., the two persons are not wearing the proper safety gear or one of the two person is not authorized by facial recognition), then access would not be granted. In some instances, the denial of access can prevent the opening of a door, prevent access to a room, prevent the use of equipment in the critical function area, or any combination thereof. To prevent use of or access to something, the multi-person access control system can send instructions to a corresponding device or system instructing the device or system to maintain a current state. In these instances, the multi-person access control system can provide messages to the two persons informing the of the condition that is not satisfied (e.g., the safety gear), send a message to supervisors describing the situation, or any combination thereof.

In some implementations, the determination for access utilizes various forms of sensor data to prevent spoofing or tricking of the multi-person access control system. For example, various sensor data can provide information about the body temperature, weight, facial expression recognition, gait analysis, the amount of movement by the person, or any other appropriate means of determining whether 1) the sensor data representing the person attempting access (e.g., the person) is likely a living human being and 2) the sensor data representing the person satisfies a threshold for recognition of a person who has authorization to access the critical function. Other appropriate means of analysis of the available sensor data can be employed to prevent persons from pretending to be an authorized person through disguises, pictures, cardboard cut-outs, voice recordings, or other various means of impersonating an authorized person. Using the various forms of sensor data, the multi-person access control system can determine when persons presenting unauthorized credentials (e.g., the PIN or RFID badge of another person), are attempting to access the critical function area and prevent access.

In some implementations, the multi-person access control system can utilize sensor data, e.g., from other systems, that represent features outside the critical function area when determining whether the sensor data captured by the system within a threshold distance of the critical area, that is different than input data from input devices, satisfies an access criteria for one or more persons present in or around the critical area. For example, the system can receive an input from a person that matches a manager's password. The multi-person access control system can access camera data from other parts of a facility and use the camera data to determine that the manager is likely located in a different area of the facility other than in or around the critical function area. In response to the multi-person access control system determining that the input to the system, e.g., the manager's password, matches the access criteria and determining using sensor data from other parts of the facility, that the person associated with the manager's password is likely located in an area other than the critical function area, the system can deny access, send an alert, perform any other appropriate action, or a combination of these.

In some implementations, the multi-person access control system can utilize sensor data, input from a person, or any appropriate means to determine whether a person attempting access is under duress. For example, a user can input a PIN proceeded by a zero to indicate duress or involuntary action for access. The multi-person access control system can determine through sensor data whether a person presents physical indications of involuntary action, such as body temperature, eye movement, gait analysis, amount of movement, speed of movement, voice analysis, or any other appropriate means to determine duress.

In some implementations, the multi-person access control system can use a combination of the data described previously to determine whether criteria for access are satisfied. The multi-person access control system can perform the analysis with or without using the action analysis engine. For example, the multi-person access control system, using sensor data from sensors at or near the critical function area, authenticate a person given the sensor data. The multi-person access control system, using input data from various input devices, authenticate the input data. In some examples, the multi-person access control system, using a combination of sensor and input data, authenticates the person, actions performed by the person, or both, e.g., given actions performed by the person. Using a combination of one or more of these authentication processes of different data, the system can authenticate a person and determine whether to grant access the person access to the critical function area.

In some implementations, the multi-person access control system can authenticate two or more persons using sensor data while authenticating at least one user with input data. For example, the multi-person access control system can determine that a first person and a second person are likely present; that the persons satisfy a threshold for being live persons; and that the input data received as a PIN from at least one of the persons a) matches the PIN associated with the person who entered the PIN and b) has authorization to access the critical function area under the currently sensed conditions.

In some implementations, the environment contains other controllable components. For example, the multi-person access control system can control lights in the area to illuminate the critical function location 116. Lighting can enable the specific illumination of the work area such as vault 140. Some examples include enabling power to tools or outlets in the critical function location 116. In some examples, recording of sensor data may begin to create records of the access or events occurring in the area.

In some implementations, the multi-person access control system can disable controllable components in the environment when conditions are not met. For example, if the correct supervisors or other people are not present within or near the location 116, high-energy tools might not be enabled. In some examples, capture of sensor data can initiate record creation for the corresponding sensor data, e.g., that represents access or events occurring in the area. This record creation can occur even when the conditions for access are not satisfied.

In some implementations, the critical function location 116 can encompass a safety area for electrical panels to which the multi-person access control system allows access if the proper safety gear is being worn. In some examples, the critical function location 116 is a tabletop for inventorying controlled material in which an alert can be sent if controlled material leaves the tabletop.

In some implementations, the cameras 108a and 108b can monitor a desk or worktable in a pharmacy and verify the products stay within the bounds of the table. The cameras can verify the correct persons remain present during an operation. For instance, the lead pharmacist can be required to stay in the area while the product is counted and distributed. In this instance, the operation can be required to stop if the lead pharmacist leaves the area.

In some implementations, the multi-person access control multi-person access control system can verify the right equipment is in place in addition to persons 120a-b. The persons 120a-b can be identified with biometrics, tokens, badges, or any combination of means to authenticate the individuals. For instance, in low lighting scenarios, the persons 120a-b can carry short range wireless devices to verify the distance and location of persons 120a-b to the critical function location 116.

Some implementations can include ensuring the correct supervisors are on sight and monitoring while certain activities are taking place. The multi-person access control system 104 can detect the presence of people through several means and can combine that detection with input from those people to verify the conditions in the room satisfy requirements. For example, if the correct number of people are in the room and the correct inputs are received by the system, then access is granted. The multi-person access control system 104 can verify prior to and during these operations that the correct people are present. It can do this through several sensory inputs and requirement criteria.

The multi-person access control system 104 can be implemented for access control to a building. For example, the owner of a business, John, may want to ensure that both the manager and at least one employee are present prior to opening the store. The critical operations assurance system is set to visually verify that two people are present and require that at least one of those people enter the pass code of the manager. The multi-person access control system may recognize the manager by facial recognition or by the pass code only, or through other means of identity verification including fobs, identification, keys, vocal recognition, or more. The second person may need to be a specific person from the operation schedule or any individual on the employment roster. The second person can enter a passcode or present some other form of validation. In response to the security settings there may need to be different or more stringent levels of authentication before access is granted. The multi-person access control system can tell whether the manager's code is entered without the presence of the manager, or whether either of the people are under duress when approaching the system.

The multi-person access control system 104 can require some or all conditions be met for access. The conditions can be defined in corresponding rules or other criteria. For instance, one condition can be that person 120a is present in the critical function location 116. In other examples, the multi-person access control system 104 can require, as a condition, that person A 120a and the correct PIN be entered into input device 112a. In some implementations, these changes can occur on a schedule in which more conditions are required for access afterhours, whereas fewer conditions a required for access during the day.

The conditions for entry can change using a schedule, manual input, or other conditions. For example, a first rule can indicate that the person B 120b can be allowed to access the vault 140 alone, and a second rule can indicate that the person A 120a must be accompanied by at least one other person. In some instances, a PIN can be required as input 112a after business hours.

In some implementations, the multi-person access control system can use biometric signatures for access criteria of the individuals present at the critical function location 116. This can reduce a likelihood of spoofing of the system with masks, obscured faces, cardboard cuts or otherwise. These implementations can prompt a person to provide “signs of life” by responding to prompts for movement. These movements could be state changes in posture such as raising a hand, prompts to answer questions, such as math solutions or vocal access phrases, or both. These measures can increase a confidence that the system has verified the correct and authorized people are present and not under duress. The multi-person access control system can continually validate the authenticity of the people present as they move throughout the activity. The actions and patterns of those being monitored can be fed into a probabilistic equation determining whether the personnel need to be queried or other supervisors need to be alerted to validate the authenticity of the people. This level of scrutiny can identify when two people who are authorized access are present, but the access codes entered do not associate with the people present. For example, employees, Mike and Lee, are authorized access, but instead of entering his own pass code, Lee enters a manager's (John's) pass code. The multi-person access control system can identify Lee through methods other than biometrics, such as gait tracking, facial recognition, video analytics, or other appropriate analytics. The system can then identify if Lee approaches a first time and uses a first credential associated with Lee and then identify if Lee approaches a second time and enters a second credential associated with John. In these situations, the system can deny access, prompt a device of the manger to authorize access remotely, or a combination of both, e.g., initially deny access until a device operated by the manager remotely authorizes access.

In some implementations, the verification of the individuals present in the area includes one or more authentication processes. An authentication process can utilize at least some of the data received from sensors in the location 116 or surrounding area, such as the input devices 112. For example, individuals can be authenticated through facial recognition using cameras. Other forms of authentication include but are not limited to using biometric data, input, smart cards, and tokens. In some examples, the multi-person access control system can utilize multi-factor authentication (MFA), one-time-passwords, or other combinations of inputs to authenticate an individual. In some instances, the authentication is approved by another person either present in the area or in a remote area.

In some implementations, the required authentication levels can change. For example, a user present in the critical function location 116 can provide authentication credentials through various sensors and input devices, such that further authentication of other individuals present is not required.

In some implementation the critical function is the supervision of pill counting at a pharmacy. The multi-person access control system can allow the pill counting to occur in a controlled environment and with the correct people present, the conditions can be monitored to ensure the correct conditions exist in the room. In some examples the system can monitor to verify that the authorized people are in the room, that the outer doors are shut and locked, and that there are not unauthorized materials in the counting area such as bags or additional bottles. The multi-person access control system can monitor the room conditions and can verify the identity of the people present to count the pills through biometric verification, code entry, or a combination of sensors. The system can continuously monitor to ensure that the personnel stay in the room and at the table while the inventory is in progress. The multi-person access control system can prompt or warn people in the area performing the operation if they begin to leave the monitored area, that the count will be invalidated if those counting distance themselves further from the monitored area. The system can send updates of the operation to the supervisor who can have a record of the successful and safe execution of the operation.

Some instances in which the multi-person access control system can ensure proper conditions exist during an evolution is tamper-proofing. When locking a cabinet or space, the system can ensure the correct personnel are present, the critical material or operation is supervised, and the space is locked. For example, when inventorying expensive electronic equipment, the system verifies through the sensors that the authorized people are present. When the operation is complete, the two or more authorized people conducting the inventory or audit can be verified by the multi-person access control system and can enter a physical code, key, fob, or other form of physical identification. This combination of monitoring through the sensor data and the input from those being monitored can create a sort of tamper seal on the activity. The activity can then later be audited for quality assurance or inventory purposes. Information associated with the critical evolution can be viewed by others. For example, the supervisor can inspect the secured area and see who was present during the evolution, who secured the area, and may even see data involved with the evolution such as inventory numbers.

In one embodiment the multi-person access control system can verify the material being operated on and can perform actions that involve the material. For example, the system can perform actions to count the material, verify the material does not leave an area, verify the material is not tampered with, or otherwise.

The multi-person access control system 104 is an example of a system implemented as computer programs on one or more computers in one or more locations, in which the systems, components, and techniques described in this specification are implemented. The input devices may include personal computers, mobile communication devices, touch pads, badge readers, and other devices that can send and receive data over a network. The network (not shown), such as a local area network (“LAN”), wide area network (“WAN”), the Internet, or a combination thereof, connects the sensors, the input devices, and the multi-person access control system 104. The multi-person access control system 104 may use a single server computer or multiple server computers operating in conjunction with one another, including, for example, a set of remote computers deployed as a cloud computing service.

The multi-person access control system 104 can include several different functional components, including an input devices 112, cameras 108, alert generation engine 105, and action analysis engine 106. Other functional components can include, but are not limited to authentication components, communication components, sensing components, and security components. The alert generation engine 105, or action analysis engine 106, or a combination of these, can include one or more data processing apparatuses, can be implemented in code, or a combination of both. For instance, each of the alert generation engine 105 and action analysis engine 106 can include one or more data processors and instructions that cause the one or more data processors to perform the operations discussed herein.

The various functional components of the multi-person access control system 104 may be installed on one or more computers as separate functional components or as different modules of a same functional component. For example, the components alert generation engine 105 and action analysis engine 106 of the multi-person access control system 104 can be implemented as computer programs installed on one or more computers in one or more locations that are coupled to each through a network. In cloud-based systems for example, these components can be implemented by individual computing nodes of a distributed computing system.

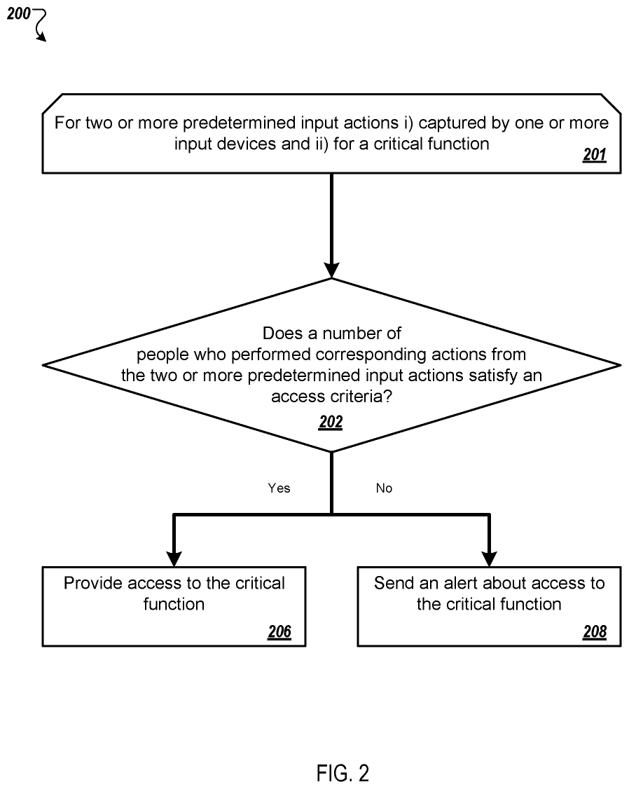

FIG. 2 is a flow diagram of a process for the multi-person access control system. For example, the process 200 can be used by the multi-person access control system 104 from the environment 100.

A multi-person access control system uses sensor data captured by one or more sensors to determine, for two or more predetermined input actions i) captured by one or more input devices and ii) for a critical function (201), whether a number of people who performed corresponding actions from the two or more predetermined input actions satisfies an access criteria (202). The multi-person access control system can identify distinct individuals with or without biometrics and track the individuals' interaction with the system. This identification can detect if one individual performs both actions even if there is more than one individual in the area. The one or more sensors can be different devices from the one or more input devices.

For example, the multi-person access control system can determine using a camera 108a, whether a person 120a at the critical function location 116 performs one of the input actions. The system can use a separate sensor to capture the input, for example, the input device 112a. An example of an input action can be entering a PIN, performing a biometric scan, performing a required action, like scanning an RFID tag or jumping, or a combination of these. The system can determine whether the two input actions are correct and the people who performed those two input actions satisfy an access criteria using the sensor data from camera 108a and input device 112a. For instance, the system can require a manager be visually present verified by means of camera 108a and the correct PIN, e.g., input action, entered into a keypad, verified by means of input device 112a. The verification can be performed on the device that captures the input, another device in the system, or a combination of these.

In response to determining whether the number of people who performed corresponding actions from the two or more predetermined input actions satisfies the access criteria, the multi-person access control system can perform an action for the critical function using a result of the determination. For example, when the correct people 120a-b are present in the critical function location 116, verified using data from the cameras 108a-b, the system can determine that these two people 120a-b being present satisfies the access criteria and perform the action of opening the vault 140. In some instances, the verification of the correct people and input data enables a function or event within the critical function location 116.

In response to determining that the number of people who performed corresponding actions from the two or more predetermined input actions satisfies the access criteria, the multi-person access control system performs an appropriate action for the critical function using a result of the determination. For instance, the system can open the vault 140. The system can perform one or more actions that relate to the critical function location 116 or to other areas. For example, the multi-person access control system can grant access to the vault, lock the entrances to the building, send a message to a supervisor that the vault is open, or a combination of these.

In some examples, the multi-person access control system provides access to the critical function (206). For example, the system can grant access to the vault 140, e.g., cause a door to the vault 140 to open. The system can log the entrance to the vault 140 and the length of time that the vault 140 was opened.

In some implementations, the multi-person access control system sends an alert about access to the critical function (208). This can occur in response to determining that the number of people who performed corresponding actions from the two or more predetermined input actions does not satisfy the access criteria. For instance, the system can turn on certain lights to alert those in the area that the vault 140 is open. The system can update a status board that the vault 140 is open. The system can send the alert to a device which alert indicates that the critical function was accessed.

In response to determining that the number of people who performed corresponding actions from the two or more predetermined input actions does not satisfy the access criteria, the multi-person access control system can continue analyzing the area for two or more predetermined input actions i) entered into one or more input devices and ii) for a critical function. For instance, the system can continue to receive sensor data captured by the one or more sensors.

In some implementations, the multi-person access control system can perform a different action, other than providing access to the critical function, in response to determining that the number of people who performed corresponding actions from the two or more predetermined input actions does not satisfy the access criteria. For instance, the system can send an alert about the access request to the critical function, e.g., perform step 208. The alert can indicate that an access request was denied, include information about the access request, or both. The information about the access request can include at least some of the sensor data.

The order of steps in the process 200 described above is illustrative only, and the multi access control system process 200 can be performed in different orders. For example, the system can send an alert about access to the critical function (208) and then provide access to the critical function (206). The system can continue to determine, for two or more predetermined input actions i) entered into one or more input devices and ii) for a critical function (201) and using sensor data captured by the one or more sensors, throughout the process 200. The system can both provide access to the critical function (206) and send an alert about access to the critical function (208).

In some implementations, the process 200 can include additional steps, fewer steps, or some of the steps can be divided into multiple steps. For example, the multi-person access control system can determine, using first sensor data captured by a first sensor, whether a first person performed a first predetermined action for a critical function that requires two or more predetermined actions, each performed by a corresponding person from people. For example, the system can verify using several methods that the correct person of the people has entered the PIN into input device 112a. The system can determine, using second sensor data captured by a second sensor, whether a second person performed a second predetermined action for the critical function that requires the two or more predetermined actions, each performed by a corresponding person from the people. For instance, the system can use a proximity sensor to detect an electronic beacon of a second person as verification that the correct people are within the critical function location 116.

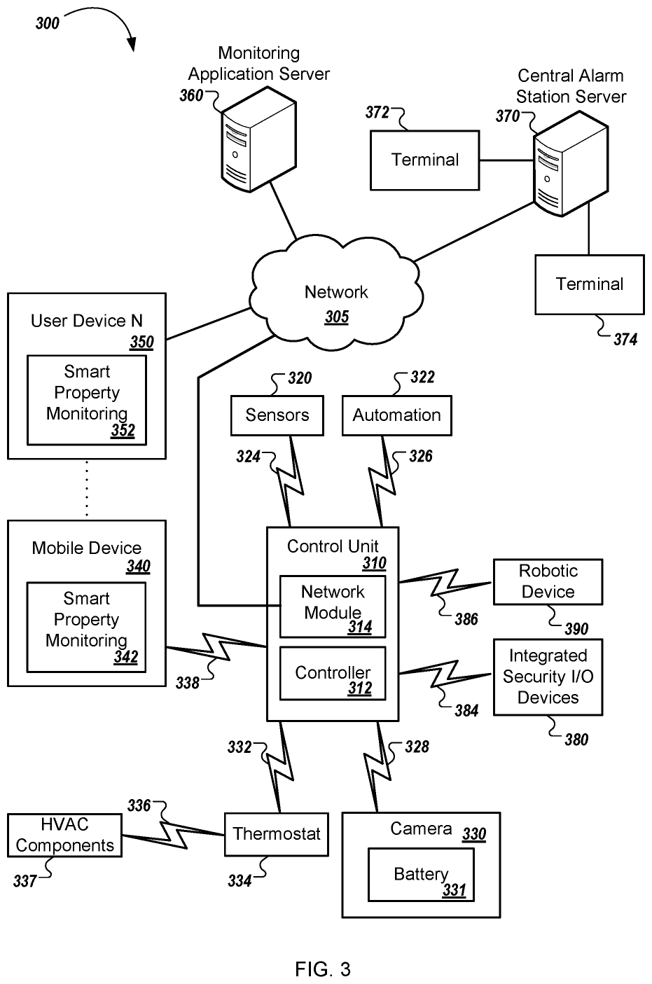

FIG. 3 is a diagram illustrating an example of a property monitoring system 300. The property monitoring system 300 includes a network 305, a control unit 310, one or more user devices 340 and 350, a monitoring application server 360, and a central alarm station server 370. In some examples, the network 305 facilitates communications between the control unit 310, the one or more user devices 340 and 350, the monitoring application server 360, and the central alarm station server 370.

The network 305 is configured to enable exchange of electronic communications between devices connected to the network 305. For example, the network 305 may be configured to enable exchange of electronic communications between the control unit 310, the one or more user devices 340 and 350, the monitoring application server 360, and the central alarm station server 370. The network 305 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 305 may include multiple networks or subnetworks, each of which may include, for example, a wired or wireless data pathway. The network 305 may include a circuit-switched network, a packet-switched data network, or any other network able to carry electronic communications (e.g., data or voice communications). For example, the network 305 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 305 may include one or more networks that include wireless data channels and wireless voice channels. The network 305 may be a wireless network, a broadband network, or a combination of networks including a wireless network and a broadband network.

The control unit 310 includes a controller 312 and a network module 314. The controller 312 is configured to control a control unit monitoring system (e.g., a control unit system) that includes the control unit 310. In some examples, the controller 312 may include a processor or other control circuitry configured to execute instructions of a program that controls operation of a control unit system. In these examples, the controller 312 may be configured to receive input from sensors, flow meters, or other devices included in the control unit system and control operations of devices included in the household (e.g., speakers, lights, doors, etc.). For example, the controller 312 may be configured to control operation of the network module 314 included in the control unit 310.

The network module 314 is a communication device configured to exchange communications over the network 305. The network module 314 may be a wireless communication module configured to exchange wireless communications over the network 305. For example, the network module 314 may be a wireless communication device configured to exchange communications over a wireless data channel and a wireless voice channel. In this example, the network module 314 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 314 also may be a wired communication module configured to exchange communications over the network 305 using a wired connection. For instance, the network module 314 may be a modem, a network interface card, or another type of network interface device. The network module 314 may be an Ethernet network card configured to enable the control unit 310 to communicate over a local area network and/or the Internet. The network module 314 also may be a voice band modem configured to enable the alarm panel to communicate over the telephone lines of Plain Old Telephone Systems (POTS).

The control unit system that includes the control unit 310 includes one or more sensors. For example, the monitoring system 300 may include multiple sensors 320. The sensors 320 may include a lock sensor, a contact sensor, a motion sensor, or any other type of sensor included in a control unit system. The sensors 320 also may include an environmental sensor, such as a temperature sensor, a water sensor, a rain sensor, a wind sensor, a light sensor, a smoke detector, a carbon monoxide detector, an air quality sensor, etc. The sensors 320 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the property. The health monitoring sensor can collect various health data, including pulse, heart rate, respiration rate, sugar or glucose level, bodily temperature, or motion data. The sensors 320 can include a radio-frequency identification (RFID) sensor that identifies a particular article that includes a pre-assigned RFID tag.

The control unit 310 communicates with the module 322 and a camera 330 to perform monitoring. The module 322 are connected to one or more devices that enable property automation, e.g., home or business automation. For instance, the module 322 may be connected to one or more lighting systems and may be configured to control operation of the one or more lighting systems. Also, the module 322 may be connected to one or more electronic locks at the property and may be configured to control operation of the one or more electronic locks (e.g., control Z-Wave locks using wireless communications in the Z-Wave protocol). Further, the module 322 may be connected to one or more appliances at the property and may be configured to control operation of the one or more appliances. The module 322 may include multiple modules that are each specific to the type of device being controlled in an automated manner. The module 322 may control the one or more devices based on commands received from the control unit 310. For instance, the module 322 may cause a lighting system to illuminate an area to provide a better image of the area when captured by a camera 330. The camera 330 can include one or more batteries 331 that require charging.

A drone 390 can be used to survey the electronic system 300. In particular, the drone 390 can capture images of each item found in the electronic system 300 and provide images to the control unit 310 for further processing. Alternatively, the drone 390 can process the images to determine an identification of the items found in the electronic system 300.

The camera 330 may be a video/photographic camera or other type of optical sensing device configured to capture images. For instance, the camera 330 may be configured to capture images of an area within a property monitored by the control unit 310. The camera 330 may be configured to capture single, static images of the area or video images of the area in which multiple images of the area are captured at a relatively high frequency (e.g., thirty images per second) or both. The camera 330 may be controlled based on commands received from the control unit 310.

The camera 330 may be triggered by several different types of techniques. For instance, a Passive Infra-Red (PIR) motion sensor may be built into the camera 330 and used to trigger the camera 330 to capture one or more images when motion is detected. The camera 330 also may include a microwave motion sensor built into the camera and used to trigger the camera 330 to capture one or more images when motion is detected. The camera 330 may have a “normally open” or “normally closed” digital input that can trigger capture of one or more images when external sensors (e.g., the sensors 320, PIR, door/window, etc.) detect motion or other events. In some implementations, the camera 330 receives a command to capture an image when external devices detect motion or another potential alarm event. The camera 330 may receive the command from the controller 312 or directly from one of the sensors 320.

In some examples, the camera 330 triggers integrated or external illuminators (e.g., Infra-Red, Z-wave controlled “white” lights, lights controlled by the module 322, etc.) to improve image quality when the scene is dark. An integrated or separate light sensor may be used to determine if illumination is desired and may result in increased image quality.

The camera 330 may be programmed with any combination of time/day schedules, system “arming state”, or other variables to determine whether images should be captured or not when triggers occur. The camera 330 may enter a low-power mode when not capturing images. In this case, the camera 330 may wake periodically to check for inbound messages from the controller 312. The camera 330 may be powered by internal, replaceable batteries, e.g., if located remotely from the control unit 310. The camera 330 may employ a small solar cell to recharge the battery when light is available. The camera 330 may be powered by the controller's 312 power supply if the camera 330 is co-located with the controller 312.

In some implementations, the camera 330 communicates directly with the monitoring application server 360 over the Internet. In these implementations, image data captured by the camera 330 does not pass through the control unit 310 and the camera 330 receives commands related to operation from the monitoring application server 360.

The system 300 also includes thermostat 334 to perform dynamic environmental control at the property. The thermostat 334 is configured to monitor temperature and/or energy consumption of an HVAC system associated with the thermostat 334 and is further configured to provide control of environmental (e.g., temperature) settings. In some implementations, the thermostat 334 can additionally or alternatively receive data relating to activity at a property and/or environmental data at a property, e.g., at various locations indoors and outdoors at the property. The thermostat 334 can directly measure energy consumption of the HVAC system associated with the thermostat or can estimate energy consumption of the HVAC system associated with the thermostat 334, for example, based on detected usage of one or more components of the HVAC system associated with the thermostat 334. The thermostat 334 can communicate temperature and/or energy monitoring information to or from the control unit 310 and can control the environmental (e.g., temperature) settings based on commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In addition, the control unit 310 can be a gateway device that communicates with the dynamically programmable thermostat 334. In some implementations, the thermostat 334 is controlled via one or more module 322.

A module 337 is connected to one or more components of an HVAC system associated with a property and is configured to control operation of the one or more components of the HVAC system. In some implementations, the module 337 is also configured to monitor energy consumption of the HVAC system components, for example, by directly measuring the energy consumption of the HVAC system components or by estimating the energy usage of the one or more HVAC system components based on detecting usage of components of the HVAC system. The module 337 can communicate energy monitoring information and the state of the HVAC system components to the thermostat 334 and can control the one or more components of the HVAC system based on commands received from the thermostat 334.

In some examples, the system 300 further includes one or more robotic devices 390. The robotic devices 390 may be any type of robots that are capable of moving and taking actions that assist in security monitoring. For example, the robotic devices 390 may include drones that are capable of moving throughout a property based on automated control technology and/or user input control provided by a user. In this example, the drones may be able to fly, roll, walk, or otherwise move about the property. The drones may include helicopter type devices (e.g., quad copters), rolling helicopter type devices (e.g., roller copter devices that can fly and also roll along the ground, walls, or ceiling) and land vehicle type devices (e.g., automated cars that drive around a property). In some cases, the robotic devices 390 may be robotic devices 390 that are intended for other purposes and merely associated with the system 300 for use in appropriate circumstances. For instance, a robotic vacuum cleaner device may be associated with the monitoring system 300 as one of the robotic devices 390 and may be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 may navigate within the property using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 390 may include control processors that process output from the various sensors and control the robotic devices 390 to move along a path that reaches the desired destination and avoids obstacles. In this regard, the control processors detect walls or other obstacles in the property and guide movement of the robotic devices 390 in a manner that avoids the walls and other obstacles.

In addition, the robotic devices 390 may store data that describes attributes of the property. For instance, the robotic devices 390 may store a floorplan and/or a three-dimensional model of the property that enables the robotic devices 390 to navigate the property. During initial configuration, the robotic devices 390 may receive the data describing attributes of the property, determine a frame of reference to the data (e.g., a property or reference location in the property), and navigate the property based on the frame of reference and the data describing attributes of the property. Further, initial configuration of the robotic devices 390 also may include learning of one or more navigation patterns in which a user provides input to control the robotic devices 390 to perform a specific navigation action (e.g., fly to an upstairs bedroom and spin around while capturing video and then return to a property charging base). In this regard, the robotic devices 390 may learn and store the navigation patterns such that the robotic devices 390 may automatically repeat the specific navigation actions upon a later request.

In some examples, the robotic devices 390 may include data capture and recording devices. In these examples, the robotic devices 390 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the property and users in the property. The one or more biometric data collection tools may be configured to collect biometric samples of a person in the property with or without contact of the person. For instance, the biometric data collection tools may include a fingerprint scanner, a hair sample collection tool, a skin cell collection tool, and/or any other tool that allows the robotic devices 390 to take and store a biometric sample that can be used to identify the person (e.g., a biometric sample with DNA that can be used for DNA testing).

In some implementations, the robotic devices 390 may include output devices. In these implementations, the robotic devices 390 may include one or more displays, one or more speakers, and/or any type of output devices that allow the robotic devices 390 to communicate information to a nearby user.

The robotic devices 390 also may include a communication module that enables the robotic devices 390 to communicate with the control unit 310, each other, and/or other devices. The communication module may be a wireless communication module that allows the robotic devices 390 to communicate wirelessly. For instance, the communication module may be a Wi-Fi module that enables the robotic devices 390 to communicate over a local wireless network at the property. The communication module further may be a 900 MHz wireless communication module that enables the robotic devices 390 to communicate directly with the control unit 310. Other types of short-range wireless communication protocols, such as Bluetooth, Bluetooth LE, Z-wave, Zigbee, etc., may be used to allow the robotic devices 390 to communicate with other devices in the property. In some implementations, the robotic devices 390 may communicate with each other or with other devices of the system 300 through the network 305.

The robotic devices 390 further may include processor and storage capabilities. The robotic devices 390 may include any suitable processing devices that enable the robotic devices 390 to operate applications and perform the actions described throughout this disclosure. In addition, the robotic devices 390 may include solid-state electronic storage that enables the robotic devices 390 to store applications, configuration data, collected sensor data, and/or any other type of information available to the robotic devices 390.

The robotic devices 390 are associated with one or more charging stations. The charging stations may be located at predefined home base or reference locations in the property. The robotic devices 390 may be configured to navigate to the charging stations after completion of tasks needed to be performed for the property monitoring system 300. For instance, after completion of a monitoring operation or upon instruction by the control unit 310, the robotic devices 390 may be configured to automatically fly to and land on one of the charging stations. In this regard, the robotic devices 390 may automatically maintain a fully charged battery in a state in which the robotic devices 390 are ready for use by the property monitoring system 300.

The charging stations may be contact based charging stations and/or wireless charging stations. For contact-based charging stations, the robotic devices 390 may have readily accessible points of contact that the robotic devices 390 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 390 may charge through a wireless exchange of power. In these cases, the robotic devices 390 need only locate themselves closely enough to the wireless charging stations for the wireless exchange of power to occur. In this regard, the positioning needed to land at a predefined home base or reference location in the property may be less precise than with a contact-based charging station. Based on the robotic devices 390 landing at a wireless charging station, the wireless charging station outputs a wireless signal that the robotic devices 390 receive and convert to a power signal that charges a battery maintained on the robotic devices 390.

In some implementations, each of the robotic devices 390 has a corresponding and assigned charging station such that the number of robotic devices 390 equals the number of charging stations. In these implementations, the robotic devices 390 always navigate to the specific charging station assigned to that robotic device. For instance, a first robotic device may always use a first charging station and a second robotic device may always use a second charging station.

In some examples, the robotic devices 390 may share charging stations. For instance, the robotic devices 390 may use one or more community charging stations that are capable of charging multiple robotic devices 390. The community charging station may be configured to charge multiple robotic devices 390 in parallel. The community charging station may be configured to charge multiple robotic devices 390 in serial such that the multiple robotic devices 390 take turns charging and, when fully charged, return to a predefined home base or reference location in the property that is not associated with a charger. The number of community charging stations may be less than the number of robotic devices 390.

Also, the charging stations might not be assigned to specific robotic devices 390 and may be capable of charging any of the robotic devices 390. In this regard, the robotic devices 390 may use any suitable, unoccupied charging station when not in use. For instance, when one of the robotic devices 390 has completed an operation or is in need of battery charge, the control unit 310 references a stored table of the occupancy status of each charging station and instructs the robotic device to navigate to the nearest charging station that is unoccupied.

The system 300 further includes one or more integrated security devices 380. The one or more integrated security devices may include any type of device used to provide alerts based on received sensor data. For instance, the one or more control units 310 may provide one or more alerts to the one or more integrated security input/output devices 380. Additionally, the one or more control units 310 may receive sensor data from the sensors 320 and determine whether to provide an alert to the one or more integrated security input/output devices 380.

The sensors 320, the module 322, the camera 330, the thermostat 334, and the integrated security devices 380 may communicate with the controller 312 over communication links 324, 326, 328, 332, 338, 384, and 386. The communication links 324, 326, 328, 332, 338, 384, and 386 may be a wired or wireless data pathway configured to transmit signals from the sensors 320, the module 322, the camera 330, the thermostat 334, the drone 390, and the integrated security devices 380 to the controller 312. The sensors 320, the module 322, the camera 330, the thermostat 334, the drone 390, and the integrated security devices 380 may continuously transmit sensed values to the controller 312, periodically transmit sensed values to the controller 312, or transmit sensed values to the controller 312 in response to a change in a sensed value. In some implementations, the drone 390 can communicate with the monitoring application server 360 over network 305. The drone 390 can connect and communicate with the monitoring application server 360 using a Wi-Fi or a cellular connection.

The communication links 324, 326, 328, 332, 338, 384, and 386 may include a local network. The sensors 320, the module 322, the camera 330, the thermostat 334, the drone 390 and the integrated security devices 380, and the controller 312 may exchange data and commands over the local network. The local network may include 802.11 “Wi-Fi” wireless Ethernet (e.g., using low-power Wi-Fi chipsets), Z-Wave, Zigbee, Bluetooth, “HomePlug” or other “Powerline” networks that operate over AC wiring, and a Category 5 (CAT5) or Category 6 (CAT6) wired Ethernet network. The local network may be a mesh network constructed based on the devices connected to the mesh network.

The monitoring application server 360 is an electronic device configured to provide monitoring services by exchanging electronic communications with the control unit 310, the one or more user devices 340 and 350, and the central alarm station server 370 over the network 305. For example, the monitoring application server 360 may be configured to monitor events (e.g., alarm events) generated by the control unit 310. In this example, the monitoring application server 360 may exchange electronic communications with the network module 314 included in the control unit 310 to receive information regarding events (e.g., alerts) detected by the control unit 310. The monitoring application server 360 also may receive information regarding events (e.g., alerts) from the one or more user devices 340 and 350.

In some examples, the monitoring application server 360 may route alert data received from the network module 314 or the one or more user devices 340 and 350 to the central alarm station server 370. For example, the monitoring application server 360 may transmit the alert data to the central alarm station server 370 over the network 305.

The monitoring application server 360 may store sensor and image data received from the monitoring system 300 and perform analysis of sensor and image data received from the monitoring system 300. Based on the analysis, the monitoring application server 360 may communicate with and control aspects of the control unit 310 or the one or more user devices 340 and 350.

The monitoring application server 360 may provide various monitoring services to the system 300. For example, the monitoring application server 360 may analyze the sensor, image, and other data to determine an activity pattern of a resident of the property monitored by the system 300. In some implementations, the monitoring application server 360 may analyze the data for alarm conditions or may determine and perform actions at the property by issuing commands to one or more of the controllers 312, possibly through the control unit 310.

The central alarm station server 370 is an electronic device configured to provide alarm monitoring service by exchanging communications with the control unit 310, the one or more mobile devices 340 and 350, and the monitoring application server 360 over the network 305. For example, the central alarm station server 370 may be configured to monitor alerting events generated by the control unit 310. In this example, the central alarm station server 370 may exchange communications with the network module 314 included in the control unit 310 to receive information regarding alerting events detected by the control unit 310. The central alarm station server 370 also may receive information regarding alerting events from the one or more mobile devices 340 and 350 and/or the monitoring application server 360.

The central alarm station server 370 is connected to multiple terminals 372 and 374. The terminals 372 and 374 may be used by operators to process alerting events. For example, the central alarm station server 370 may route alerting data to the terminals 372 and 374 to enable an operator to process the alerting data. The terminals 372 and 374 may include general-purpose computers (e.g., desktop personal computers, workstations, or laptop computers) that are configured to receive alerting data from a server in the central alarm station server 370 and render a display of information based on the alerting data. For instance, the controller 312 may control the network module 314 to transmit, to the central alarm station server 370, alerting data indicating that a sensor 320 detected motion from a motion sensor via the sensors 320. The central alarm station server 370 may receive the alerting data and route the alerting data to the terminal 372 for processing by an operator associated with the terminal 372. The terminal 372 may render a display to the operator that includes information associated with the alerting event (e.g., the lock sensor data, the motion sensor data, the contact sensor data, etc.) and the operator may handle the alerting event based on the displayed information.

In some implementations, the terminals 372 and 374 may be mobile devices or devices designed for a specific function. Although FIG. 3 illustrates two terminals for brevity, actual implementations may include more (and, perhaps, many more) terminals.

The one or more user devices 340 and 350 are devices that host and display user interfaces. For instance, the user device 340 is a mobile device that hosts or runs one or more native applications (e.g., the smart property application 342). The user device 340 may be a cellular phone or a non-cellular locally networked device with a display. The user device 340 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 340 may perform functions unrelated to the monitoring system, such as placing personal telephone calls, playing music, playing video, displaying pictures, browsing the Internet, maintaining an electronic calendar, etc.

The user device 340 includes a smart property application 342. The smart property application 342 refers to a software/firmware program running on the corresponding mobile device that enables the user interface and features described throughout. The user device 340 may load or install the smart property application 342 based on data received over a network or data received from local media. The smart property application 342 runs on mobile devices platforms, such as iPhone, iPod touch, Blackberry, Google Android, Windows Mobile, etc. The smart property application 342 enables the user device 340 to receive and process image and sensor data from the monitoring system.

The user device 350 may be a general-purpose computer (e.g., a desktop personal computer, a workstation, or a laptop computer) that is configured to communicate with the monitoring application server 360 and/or the control unit 310 over the network 305. The user device 350 may be configured to display a smart property user interface 352 that is generated by the user device 350 or generated by the monitoring application server 360. For example, the user device 350 may be configured to display a user interface (e.g., a web page) provided by the monitoring application server 360 that enables a user to perceive images captured by the camera 330 and/or reports related to the monitoring system. Although FIG. 3 illustrates two user devices for brevity, actual implementations may include more (and, perhaps, many more) or fewer user devices.

In some implementations, the one or more user devices 340 and 350 communicate with and receive monitoring system data from the control unit 310 using the communication link 338. For instance, the one or more user devices 340 and 350 may communicate with the control unit 310 using various local wireless protocols such as Wi-Fi, Bluetooth, Z-wave, Zigbee, HomePlug (Ethernet over power line), or wired protocols such as Ethernet and USB, to connect the one or more user devices 340 and 350 to local security and automation equipment. The one or more user devices 340 and 350 may connect locally to the monitoring system and its sensors and other devices. The local connection may improve the speed of status and control communications because communicating through the network 305 with a remote server (e.g., the monitoring application server 360) may be significantly slower.

Although the one or more user devices 340 and 350 are shown as communicating with the control unit 310, the one or more user devices 340 and 350 may communicate directly with the sensors and other devices controlled by the control unit 310. In some implementations, the one or more user devices 340 and 350 replace the control unit 310 and perform the functions of the control unit 310 for local monitoring and long range/offsite communication.

In other implementations, the one or more user devices 340 and 350 receive monitoring system data captured by the control unit 310 through the network 305. The one or more user devices 340, 350 may receive the data from the control unit 310 through the network 305 or the monitoring application server 360 may relay data received from the control unit 310 to the one or more user devices 340 and 350 through the network 305. In this regard, the monitoring application server 360 may facilitate communication between the one or more user devices 340 and 350 and the monitoring system.

In some implementations, the one or more user devices 340 and 350 may be configured to switch whether the one or more user devices 340 and 350 communicate with the control unit 310 directly (e.g., through link 338) or through the monitoring application server 360 (e.g., through network 305) based on a location of the one or more user devices 340 and 350. For instance, when the one or more user devices 340 and 350 are located close to the control unit 310 and in range to communicate directly with the control unit 310, the one or more user devices 340 and 350 use direct communication. When the one or more user devices 340 and 350 are located far from the control unit 310 and not in range to communicate directly with the control unit 310, the one or more user devices 340 and 350 use communication through the monitoring application server 360.

Although the one or more user devices 340 and 350 are shown as being connected to the network 305, in some implementations, the one or more user devices 340 and 350 are not connected to the network 305. In these implementations, the one or more user devices 340 and 350 communicate directly with one or more of the monitoring system components and no network (e.g., Internet) connection or reliance on remote servers is needed.

In some implementations, the one or more user devices 340 and 350 are used in conjunction with only local sensors and/or local devices in a house. In these implementations, the system 300 includes the one or more user devices 340 and 350, the sensors 320, the module 322, the camera 330, and the robotic devices, e.g., that can include the drone 390. The one or more user devices 340 and 350 receive data directly from the sensors 320, the module 322, the camera 330, and the robotic devices and sends data directly to the sensors 320, the module 322, the camera 330, and the robotic devices. The one or more user devices 340, 350 provide the appropriate interfaces/processing to provide visual surveillance and reporting.

In other implementations, the system 300 further includes network 305 and the sensors 320, the module 322, the camera 330, the thermostat 334, and the robotic devices are configured to communicate sensor and image data to the one or more user devices 340 and 350 over network 305 (e.g., the Internet, cellular network, etc.). In yet another implementation, the sensors 320, the module 322, the camera 330, the thermostat 334, and the robotic devices are intelligent enough to change the communication pathway from a direct local pathway when the one or more user devices 340 and 350 are in close physical proximity to the sensors 320, the module 322, the camera 330, the thermostat 334, and the robotic devices to a pathway over network 305 when the one or more user devices 340 and 350 are farther from the sensors 320, the module 322, the camera 330, the thermostat 334, and the robotic devices. In some examples, the system leverages GPS information from the one or more user devices 340 and 350 to determine whether the one or more user devices 340 and 350 are close enough to the sensors 320, the module 322, the camera 330, the thermostat 334, and the robotic devices to use the direct local pathway or whether the one or more user devices 340 and 350 are far enough from the sensors 320, the module 322, the camera 330, the thermostat 334, and the robotic devices that the pathway over network 305 is required. In other examples, the system leverages status communications (e.g., pinging) between the one or more user devices 340 and 350 and the sensors 320, the module 322, the camera 330, the thermostat 334, and the robotic devices to determine whether communication using the direct local pathway is possible. If communication using the direct local pathway is possible, the one or more user devices 340 and 350 communicate with the sensors 320, the module 322, the camera 330, the thermostat 334, and the robotic devices using the direct local pathway. If communication using the direct local pathway is not possible, the one or more user devices 340 and 350 communicate with the sensors 320, the module 322, the camera 330, the thermostat 334, and the robotic devices using the pathway over network 305.

In some implementations, the system 300 provides end users with access to images captured by the camera 330 to aid in decision-making. The system 300 may transmit the images captured by the camera 330 over a wireless WAN network to the user devices 340 and 350. Because transmission over a wireless WAN network may be relatively expensive, the system 300 can use several techniques to reduce costs while providing access to significant levels of useful visual information (e.g., compressing data, down-sampling data, sending data only over inexpensive LAN connections, or other techniques).

In some implementations, a state of the monitoring system 300 and other events sensed by the monitoring system 300 may be used to enable/disable video/image recording devices (e.g., the camera 330). In these implementations, the camera 330 may be set to capture images on a periodic basis when the alarm system is armed in an “away” state, but set not to capture images when the alarm system is armed in a “stay” state or disarmed. In addition, the camera 330 may be triggered to begin capturing images when the alarm system detects an event, such as an alarm event, a door-opening event for a door that leads to an area within a field of view of the camera 330, or motion in the area within the field of view of the camera 330. In other implementations, the camera 330 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A method, comprising:
determining, by a system and using sensor data i) captured by one or more sensors and ii) that is different data than input data captured by one or more input devices, whether a number of people, who performed corresponding input actions, satisfies an access criteria a) for accessing a critical function and b) that requires two or more predetermined input actions; and
performing, by the system, an action for the critical function in response to determining whether the number of people, who performed corresponding input actions, satisfies the access criteria a) for accessing the critical function and b) that requires the two or more predetermined input actions.

2. The method of claim 1, wherein performing the action comprises providing access to the critical function in response to determining that the number of people, who performed corresponding input actions, satisfies the access criteria a) for accessing the critical function and b) that requires the two or more predetermined input actions.

3. The method of claim 2, comprising determining that each of the two or more predetermined input actions was performed by a different person from the people who performed corresponding input actions,
wherein performing the action is responsive to determining that each of the two or more predetermined input actions was performed by a different person from the people who performed corresponding input actions.

4. The method of claim 1, wherein performing the action comprises sending an alert about access to the critical function.

5. The method of claim 4, wherein sending the alert about the access to the critical function is responsive to determining that the number of people, who performed corresponding input actions, does not satisfy the access criteria a) for accessing the critical function and b) that requires the two or more predetermined input actions.

6. The method of claim 1, comprising accessing the input data that indicates input entered into the one or more input devices by a corresponding person.

7. The method of claim 1, wherein determining whether the number of people, who performed the corresponding input actions, satisfies the access criteria a) for accessing the critical function and b) that requires the two or more predetermined input actions comprises comparing first image data depicting a first person who performed a first input action with second image data depicting a second person who performed a second input action.

8. The method of claim 7, wherein comparing the first image data depicting the first person who performed the first input action with the second image data depicting the second person who performed the second input action comprises at least one of:
analyzing, using a facial recognition process, at least one of the first image data or the second image data; or
analyzing, using gait analysis, at least a portion of data from at least one of the first image data and the second image data.

9. The method of claim 1, wherein determining whether the number of people, who performed the corresponding input actions, satisfies the access criteria a) for accessing the critical function and b) that requires the two or more predetermined input actions comprises determining a likelihood that the sensor data indicates that the people are likely living humans.

10. The method of claim 9 wherein determining a likelihood that the sensor data indicates that the people are likely living humans uses an amount of movement of a corresponding object detected in the sensor data.

11. The method of claim 1, wherein determining whether the number of people, who performed the corresponding input actions, satisfies the access criteria a) for accessing the critical function and b) that requires the two or more predetermined input actions comprises determining whether a number of input actions matches the number of people depicted in image data captured at one or more locations where the input actions were performed.

12. The method of claim 1, wherein determining whether the number of people, who performed the corresponding input actions, satisfies the access criteria a) for accessing the critical function and b) that requires the two or more predetermined input actions comprises determining whether each of the two or more predetermined input actions was likely performed voluntarily.

13. The method of claim 1, wherein determining whether each of the two or more input actions was likely performed voluntarily uses at least one of image data or audio data.

14. One or more non-transitory computer storage media encoded with instructions that, when executed by one or more computers, cause the one or more computers to perform operations comprising:
determining, by a system and using sensor data i) captured by one or more sensors and ii) that is different data than input data captured by one or more input devices, whether a number of people, who performed corresponding input actions, satisfies an access criteria a) for accessing a critical function and b) that requires two or more predetermined input actions; and
performing, by the system, an action for the critical function in response to determining whether the number of people, who performed corresponding input actions, satisfies the access criteria a) for accessing the critical function and b) that requires the two or more predetermined input actions.

15. The computer storage media of claim 14, wherein performing the action comprises providing access to the critical function in response to determining that the number of people, who performed corresponding input actions, satisfies the access criteria a) for accessing the critical function and b) that requires the two or more predetermined input actions.

16. The computer storage media of claim 15, comprising determining that each of the two or more predetermined input actions was performed by a different person from the people who performed corresponding input actions,
wherein performing the action is responsive to determining that each of the two or more predetermined input actions was performed by a different person from the people who performed corresponding input actions.

17. The computer storage media of claim 14, wherein performing the action comprises sending an alert about access to the critical function.

18. The computer storage media of claim 17, wherein sending the alert about the access to the critical function is responsive to determining that the number of people, who performed corresponding input actions, does not satisfy the access criteria a) for accessing the critical function and b) that requires the two or more predetermined input actions.

19. The computer storage media of claim 14, wherein determining whether the number of people, who performed the corresponding input actions, satisfies the access criteria a) for accessing the critical function and b) that requires the two or more predetermined input actions comprises comparing first image data depicting a first person who performed a first input action with second image data depicting a second person who performed a second input action.

20. A system comprising one or more computers and one or more storage devices on which are stored instructions that are operable, when executed by the one or more computers, to cause the one or more computers to perform operations comprising: determining, by a system and using sensor data i) captured by one or more sensors and ii) that is different data than input data captured by one or more input devices, whether a number of people, who performed corresponding input actions, satisfies an access criteria a) for accessing a critical function and b) that requires two or more predetermined input actions; and
performing, by the system, an action for the critical function in response to determining whether the number of people, who performed corresponding input actions, satisfies the access criteria a) for accessing the critical function and b) that requires the two or more predetermined input actions.
